(19) United States
(12) Patent Application Publication
(10) Pub. No.: US 2026/0340564 A1
(43) Pub. Date: Oct. 29, 2026

(54) PREPARATION ASSISTANCE SYSTEM, PREPARATION ASSISTANCE APPARATUS, AND PREPARATION ASSISTANCE METHOD

(71) Applicant: Hitachi, Ltd., Tokyo (JP)

(72) Inventors: Hideyuki MAKI, Tokyo (JP); Toshiyuki ONO, Tokyo (JP); Masao ISHIGURO, Tokyo (JP); Akira MAEKI, Tokyo (JP); Koh KAJII, Tokyo (JP)

(21) Appl. No.: 19/542,050

(22) Filed: Feb. 17, 2026

(30) Foreign Application Priority Data
Apr. 25, 2025 (JP) 2025-072831

(51) Int. Cl. G06Q 10/067; G06F 16/334; G06F 40/169

(52) U.S. Cl. CPC G06Q 10/067; G06F 16/334; G06F 40/169

(57) ABSTRACT

The present invention is directed to providing a technique capable of indicating improvement policy of a business concept. A preparation assistance system includes a processor, a memory, and a storage unit including a plurality of pieces of comment data, and assists in preparation of a business concept, the business concept includes description data of items and description content, each of the plurality of pieces of comment data is classified into one or a plurality of categories, a correspondence relationship is defined in advance between the items of the business concept and the categories of the comment data, and the memory includes a processing command for causing the processor to function so as to search for first comment data from the plurality of pieces of comment data based on the correspondence relationship and search for second comment data from the first comment data based on the description content of the business concept.

### CROSS-REFERENCE TO RELATED APPLICATION

The present application claims priority to Japanese Patent Application No. 2025-072831, filed Apr. 25, 2025. The contents of this application are incorporated herein by reference in their entirety.

### BACKGROUND OF THE INVENTION

### Field of the Invention

The present invention relates to a preparation assistance system, a preparation assistance apparatus, and a preparation assistance method.

### Description of the Related Art

Enterprises and organizations develop a business concept when planning a new service to clarify a purpose, a goal, business details, a target, a business model, a strategy, and the like. The business concept is prepared while uncertainty of the market, restriction of resources, risk management, legal/regulatory issues, and the like, are also taken into account. Taking into account various factors in this manner sometimes makes it extremely difficult to prepare the business concept.

As a method for preparing a business concept, there are, for example, techniques disclosed in Japanese Patent Laid-Open Publication No. H07-311764 and Japanese Patent Laid-Open Publication No. 2005-182559. An object of Japanese Patent Laid-Open Publication No. H07-311764 is to "provide a document examination read support system capable of informing relative members of addition of comments to a document and also classifying, rearranging, and retrieving the comments, displaying a transition state of the comments, and supporting examination read operation according to a flow of the examination read operation", and discloses the following as an invention of a document examination read assistance system. "A client 1 and a server 2 are connected through a network 3, and the server 2 is equipped with comment information means 200 which informs relative members of addition of comments and comment retrieval means 201 which retrieves comments and stores and takes out them, and the client 1 is equipped with comment management means 104 which manages display, addition, storage, and the like, of the comments and examination read operation management means 105 which monitors flow of the examination read operation and performs proper indication and information."

Further, an object of Japanese Patent Laid-Open Publication No. 2005-182559 is to "improve precision of determining whether or not to adopt execution of a strategy plan, and to make it possible to quickly plan a strategy with high quality", and discloses the following as an invention of a strategy planning assistance method and a strategy planning assistance system. "A plurality of process steps required for evaluation of a strategy is defined in advance to evaluate a degree of completion of the business strategy, and, for each process step, an examination work sheet is made to correspond to input an examination result, and an index of the degree of completion of the strategy is calculated based on information indicating whether or not the work sheets have been created. Further, each work sheet is provided with answer input fields for profitability evaluation items in order to evaluate profitability of the strategy, and an index of the profitability of the strategy is calculated based on inputted answer information".

The business concept indicates policy for making decisions of resource distribution, fund procurement, and the like. In order to increase a degree of certainty of success in business, work of further improving content of the business concept that has been prepared once is required. In the method of Japanese Patent Laid-Open Publication No. H07-311764 and Japanese Patent Laid-Open Publication No. 2005-182559, how the details that have been prepared once should be corrected or rewritten is not specifically indicated.

Further, typically, there is a case where evaluation such as confirmation and review of a certain business concept is performed in a management meeting, a business planning meeting, and the like. Such evaluation is sometimes common to other business concepts, and thus, it is desirable to utilize the evaluation to improve other business concepts.

It is therefore an object of the present invention to provide a technique capable of indicating improvement policy of a business concept.

### SUMMARY OF THE INVENTION

To solve the above-described problem, one typical aspect of a preparation assistance system of the present invention includes a processor, a memory, and a storage unit including a plurality of pieces of comment data, and assists in preparation of a business concept, the business concept includes description data including items and description content, each of the plurality of pieces of comment data is classified into one or a plurality of categories, a correspondence relationship is defined in advance between the items of the business concept and the categories of the comment data, and the memory includes a processing command for causing the processor to function so as to search for first comment data from the plurality of pieces of comment data based on the correspondence relationship, and search for second comment data from the first comment data based on the description content of the business concept.

According to the present invention, it is possible to indicate improvement policy of a business concept.

Problems, configurations, and effects other than those described above will become clear by the following detailed description of the preferred embodiments.

### BRIEF DESCRIPTION OF THE DRAWINGS

FIG. 1 is a view schematically indicating processing to be performed in a preparation assistance system;

FIG. 2 is a view illustrating an example of a case where the preparation assistance system is constituted with hardware;

FIG. 3 is a view indicating an example of a data structure of a business concept;

FIG. 4 is a view indicating creation order in the case of preparing an improvement plan in the preparation assistance system;

FIG. 5 is a view illustrating an example of a user interface screen in a case where business concept input is performed;

FIG. 6 is a view indicating an example of creation order of an improvement plan in a case where description content of description data is fixed;

FIG. 7 is a view schematically indicating processing of comment search;

FIG. 8 is a view schematically indicating a method for extracting a comment that matches the description content;

FIG. 9 is a view indicating an example of a data structure of the business concept;

FIG. 10 is a view indicating an example in a case where a dependency relationship between items of the business concept is represented in a data structure;

FIG. 11 is a view indicating an example of a data structure of accumulated comments;

FIG. 12 is a view indicating an example of a correspondence relationship between the items of the business concept and category classifications of comment data;

FIG. 13 is a flowchart indicating processing of comment search;

FIG. 14 is a flowchart indicating details of step S5 in FIG. 13;

FIG. 15 is a flowchart indicating processing of preparation assistance of the business concept;

FIG. 16 is a flowchart indicating details of processing (step S101) of determining order of items to be created among the processing indicated in FIG. 15;

FIG. 17 is a view indicating an example of an instruction to a document processing apparatus; and

FIG. 18 is a view indicating an example of a format of a result output.

### DETAILED DESCRIPTION OF THE PREFERRED EMBODIMENT

An embodiment of the present invention will be described below with reference to the drawings. Note that the present invention is not limited by the embodiment. Further, in the drawings, the same portions will be denoted by the same reference numerals.

In a case where there is a plurality of components having the same or similar functions, there is a case where description will be provided while different suffixes (superscripts or subscripts) are attached to the same reference numerals. Further, in a case where it is not necessary to distinguish these plurality of components, there is a case where description will be provided while suffixes are omitted.

A position, size, shape, range, and the like, of each component illustrated in the drawings may not represent an actual position, size, shape, range, and the like, to facilitate understanding of the invention. Thus, the present invention is not necessarily limited to the positions, sizes, shapes, ranges, and the like, disclosed in the drawings.

### Processing of Preparation Assistance System

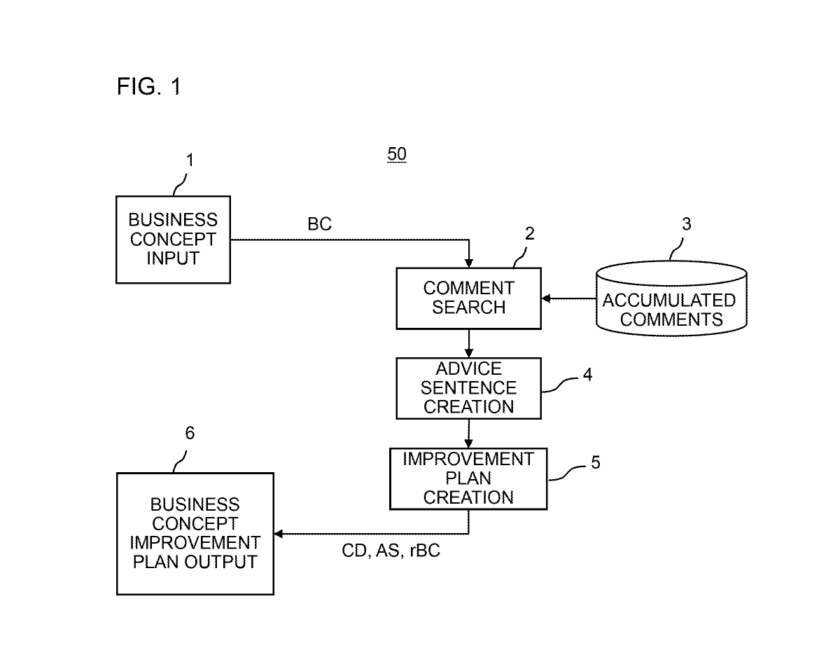

FIG. 1 is a view schematically indicating processing to be performed in a preparation assistance system 50. In the preparation assistance system 50, processing of business concept input 1, comment search 2, advice sentence creation 4, improvement plan creation 5, and business concept improvement plan output 6 is performed in this order. The business concept input 1 is performed by a user of the preparation assistance system 50. In the business concept input 1, a business concept BC is input to the preparation assistance system 50. The business concept BC includes description data including items and description content. Then, the preparation assistance system 50 performs the comment search 2 to search for comment data CD including a comment that matches the input business concept BC from accumulated comments 3. A plurality of pieces of comment data CD stored in the accumulated comments 3 includes results of evaluation performed for other business concepts different from the business concept BC. For example, the comment data CD includes statements in meetings in a case where other business concepts have come up for discussion in a management meeting, a business planning meeting, and the like, evaluation results in a case where other business concepts are prepared, and the like.

Then, the preparation assistance system 50 performs the advice sentence creation 4 and the improvement plan creation 5 to prepare an advice sentence AS for the business concept and an improvement plan rBC of the business concept BC using the comment that has been searched for. The preparation assistance system 50 presents the extracted comment, and the created advice sentence and improvement plan to the user as the business concept improvement plan output 6.

### Configuration of Preparation Assistance System

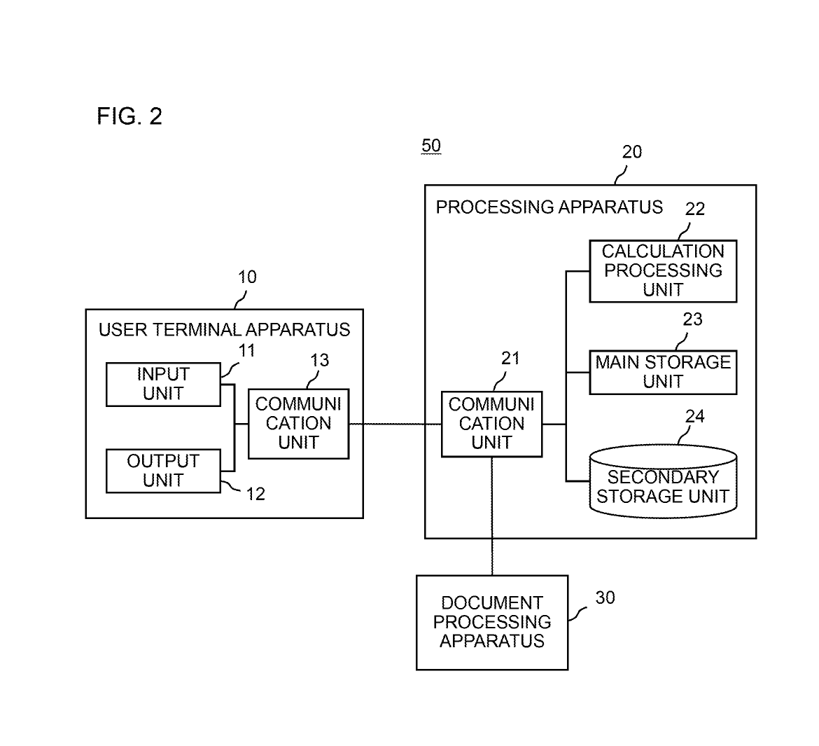

FIG. 2 is a view illustrating an example in a case where the preparation assistance system 50 is constituted with hardware. The preparation assistance system 50 includes a user terminal apparatus 10, a processing apparatus 20, and a document processing apparatus 30. The user terminal apparatus 10 is a user interface that acquires a business concept input by the user. Specifically, the user terminal apparatus 10 includes an input unit 11, an output unit 12, and a communication unit 13. The input unit 11 is an apparatus that allows the user to input data, and the like, to the preparation assistance system 50. Use of the input unit 11 allows the user to provide information to the preparation assistance system 50 and perform various kinds of operation. The user inputs the business concept BC to the preparation assistance system 50 using the input unit 11. As the input unit 11, a keyboard, a mouse, a touch pad, a touch screen, a scanner, a microphone, and the like, can be used.

The output unit 12 displays information input by the user or information created by the preparation assistance system 50. The user recognizes an advice sentence and an improvement plan created by the preparation assistance system 50 via the output unit 12. As the output unit 12, a monitor, a printer, a speaker, a projector, a headphone, and the like, can be used. The communication unit 13 is an apparatus for transmitting/receiving data between the user terminal apparatus 10 and the processing apparatus 20. The communication unit 13 includes, for example, hardware (such as, for example, a network interface card (NIC)) for connecting to a network in a wired or wireless manner, software that manages communication, and the like.

The processing apparatus 20 is an apparatus that includes a processor (calculation processing unit 22), a memory (main storage unit 23), and a storage unit (secondary storage unit 24) including a plurality of pieces of comment data and that assists in preparation of a business concept. Specifically, the processing apparatus 20 includes a communication unit 21, the calculation processing unit 22, the main storage unit 23, and the secondary storage unit 24. The communication unit 21 is connected to the communication unit 13 of the user terminal apparatus 10 and responds to the user terminal apparatus 10 in response to a request transmitted from the user terminal apparatus 10. The communication unit 21 includes hardware (such as, for example, a network interface card (NIC)) for connecting to a network, software that manages communication, and the like, in a similar manner to the communication unit 13.

The calculation processing unit (processor) 22 has a control function of executing a processing command (program) and instructing other components, and a calculation function of performing logical operation. As the calculation processing unit 22, a central processing unit (CPU), a graphics processing unit (GPU), a field-programmable gate array (FPGA), an application specific integrated circuit (ASIC), a tensor processing unit (TPU), and the like, can be used. The main storage unit 23 is a high-speed storage apparatus for temporarily storing, for example, a program and data that is being executed by the calculation processing unit 22. As the main storage unit (memory) 23, a RAM, a cache memory, a ROM, and the like, can be used. The secondary storage unit (storage unit) 24 is a storage apparatus for storing, for example, data and a program. As the secondary storage unit 24, a hard disc drive (HDD), a solid state drive (SSD), an external storage such as a USB memory and an external hard disc, an optical disc such as a CD and a DVD, and the like, can be used.

For example, the secondary storage unit 24 stores a plurality of pieces of comment data CD constituting an aggregate of comments. The comment data CD may be prepared in advance and stored in the secondary storage unit 24 or may be created by the document processing apparatus 30 which will be described later. Further, the secondary storage unit 24 has history information of preparation assistance of a business concept. The history information includes, for example, the business concept BC that is a target of preparation assistance, the improvement plan rBC, comment data extracted until the improvement plan rBC is prepared, and the like.

The document processing apparatus 30 is an apparatus for efficiently performing document creation, automatic classification, data extraction, and the like. As will be described later, the document processing apparatus 30 extracts the comment data CD, creates an advice sentence, and creates an improvement plan. Note that the document processing apparatus 30 can also create the comment data CD while providing a predetermined classification to text data. The comment data CD created by the document processing apparatus 30 is stored in the secondary storage unit 24 of the processing apparatus 20. The document processing apparatus 30 is an apparatus having a language processing function using artificial intelligence (AI).

### Data Structure of Business Concept and Dependency Relationship between Items

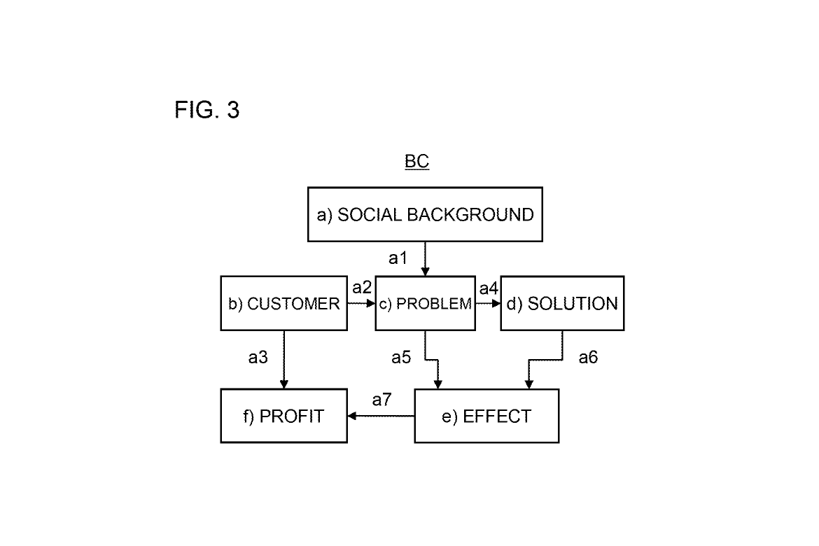

FIG. 3 is a view indicating an example of a data structure of the business concept BC. The business concept BC includes data classified into six items of (a) social background, (b) customer, (c) problem, (d) solution, (e) effect, and (f) profit. While a case will be described in the present disclosure where the business concept BC includes the above-described six items, the present disclosure is not limited to this case. It is assumed that the business concept BC includes at least one of the above-described six items. Note that alphabetical order is provided to the items for convenience sake, and both alphabets (for example, "(a)") and items (for example, "social background") are described. In business concept input 1 indicated in FIG. 1, the user of the preparation assistance system 50 inputs content for each item to prepare a business concept. The business concept BC includes description data including items and description content input in association with the items and is input to the preparation assistance system 50. The improvement plan rBC of the business concept BC has the same data structure as the data structure of the business concept BC and has common items, but description content is changed.

While the business concept BC is data input by the user, the preparation assistance system 50 proposes an improvement plan of the input business concept BC. In a case where the preparation assistance system 50 creates the improvement plan rBC, the preparation assistance system 50 performs creation processing of text based on a dependency relationship defined between the items included in the business concept BC. Arrows indicated in FIG. 3 indicate the dependency relationship defined between the items. The dependency relationship is used in a case where the processing apparatus 20 creates an advice sentence and an improvement plan. In FIG. 3, an arrow a1 points from (a) social background to (c) problem. An arrow a2 points from (b) customer to (c) problem. An arrow a3 points from (b) customer to (f) profit. An arrow a4 points from (c) problem to (d) solution. An arrow a5 points from (c) problem to (e) effect. An arrow a6 points from (d) solution to (e) effect. An arrow a7 points from (e) effect to (f) profit. In the processing apparatus 20, description content of an item on a source side (hereinafter, may be referred to as an "upstream") of an arrow becomes an origin, and content of an item on a destination side (hereinafter, may be referred to as a "downstream") of the arrow is affected. Note that the dependency relationship may be defined in advance in the preparation assistance system 50 or may be set by the user.

### Creation Order of Improvement Plan

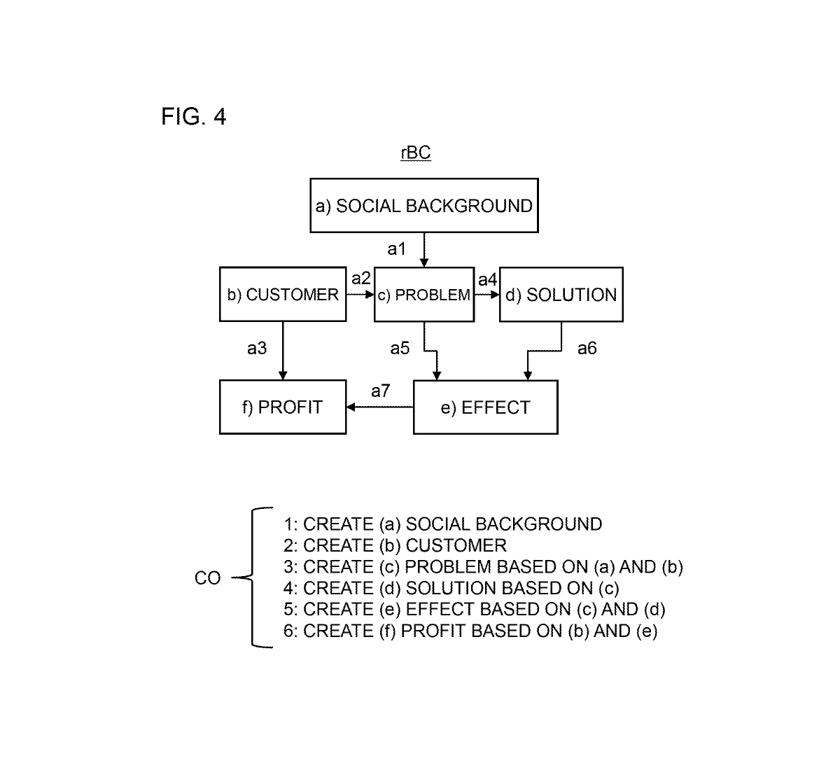

FIG. 4 is a view indicating creation order CO in a case where the improvement plan rBC is prepared in the preparation assistance system 50. In the creation processing of the improvement plan rBC, description data of the downstream item in the dependency relationship is affected by content of the description data of the upstream item, and thus, the description content is created starting from the upstream item. The most upstream items among the items indicated in FIG. 4, that is, items not having items on the upstream side of the items are the item of (a) social background and the item of (b) customer, and thus, description content of the item of (a) social background and the item of (b) customer is created prior to other items. There is no dependency relationship between the item of (a) social background and the item of (b) customer, and thus, whichever description content may be created first, but the description content of the item of (a) social background is created first in view of the alphabetical order. Thereafter, the description content is created in the order from the items on the upstream side in accordance with the order of the dependency relationship. As indicated in the creation order CO, the preparation assistance system 50 first creates an improvement plan (hereinafter, also referred to as "improvement description content") of the description content of the item of (a) social background. Then, the preparation assistance system 50 second creates improvement description content of (b) customer. Then, the preparation assistance system 50 third creates improvement description content of (c) problem based on the improvement description content of (a) social background and the improvement description content of (b) customer in accordance with the arrow a2. Then, the preparation assistance system 50 fourth creates improvement description content of (d) solution based on the improvement description content of (c) problem in accordance with the arrow a4. Then, the preparation assistance system 50 fifth creates improvement description content of (e) effect based on the improvement description content of (c) problem and the improvement description content of (d) solution in accordance with the arrows a5 and a6. Then, the preparation assistance system 50 sixth creates the improvement description content of (f) profit based on the improvement description content of (b) customer and the improvement description content of (e) effect in accordance with the arrows a3 and a7.

Further, there is a case where the business concept BC is input to the preparation assistance system 50 in a state where description of the description content is incomplete, or there is no description. Even in such a situation, the preparation assistance system 50 can change the description content or create the description content itself in accordance with the creation order CO.

### Business Concept Input

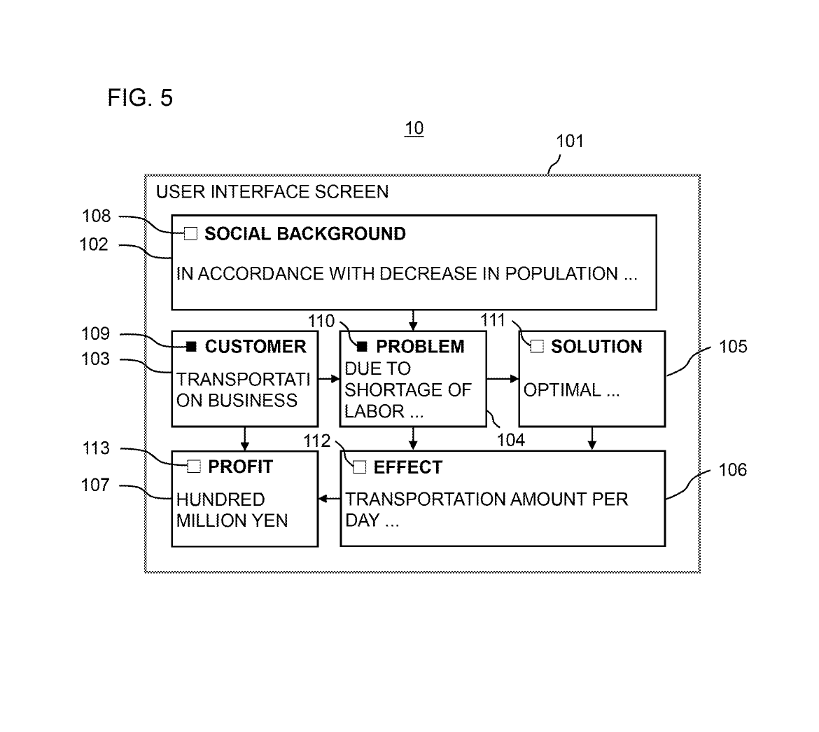

FIG. 5 is a view illustrating an example of a user interface screen in a case where business concept input 1 is performed. The user interface screen 101 is indicated at the input unit 11 and the output unit 12 of the user terminal apparatus 10. The user inputs the business concept BC to the preparation assistance system 50 while confirming the user interface screen 101. A text area 102 is a portion in which description content corresponding to (a) social background is to be input. In the text area 102, description content of "in accordance with decrease in population ..." is input. In a similar manner, text areas 103 to 107 are respectively portions in which data regarding (b) customer, (c) problem, (d) solution, (e) effect, and (f) profit is to be input. The text areas 102 to 107 are linked with arrows similar to the arrows a1 to a7 indicating the dependency relationship.

Checkboxes 108 to 113 indicate designation information designating items for which description content is fixed in the processing of improvement plan creation 5. For example, the checkbox 108 is not selected, and thus, the description content for the description data of (a) social background is improved in the processing of improvement plan creation 5, and improvement description content is created. Checkboxes 111 to 113 are not selected, either, and thus, the description data of (d) solution, (e) effect, and (f) profit is subject to the processing of improvement plan creation 5.

On the other hand, the checkbox 109 is selected, and thus, the description content is fixed (not changed) for the description data of (b) customer in the processing of improvement plan creation 5, and the description content of (b) customer is not subject to creation of the improvement description content. The checkbox 110 is also selected, and thus, the description data of (c) problem is not subject to the processing of improvement plan creation 5. In this manner, the user can select items for which the content is to be fixed among the items of the business concept BC and set the designation information via the user interface screen 101.

### Creation Order of Improvement Plan in a Case Where Description Content of Description Data is Fixed

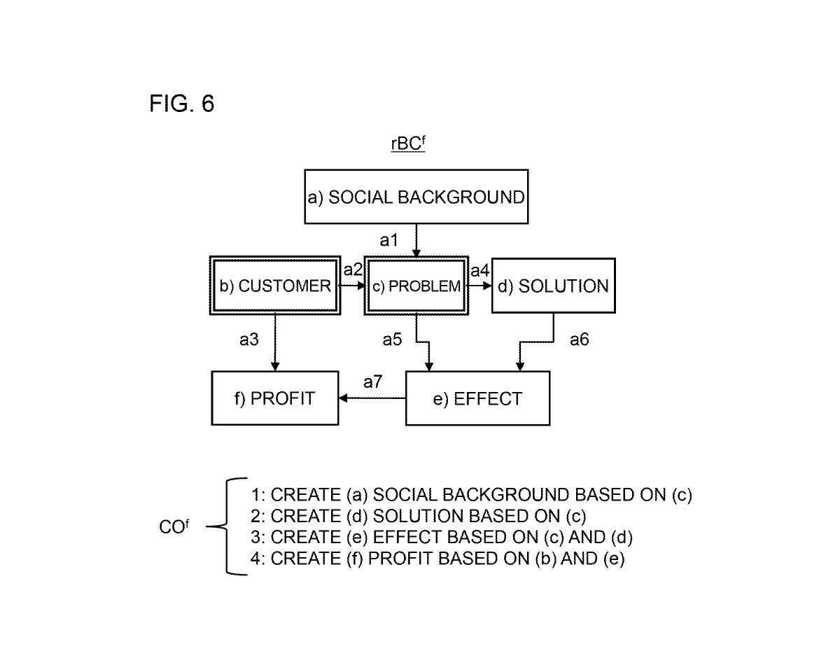

FIG. 6 is a view indicating an example of creation order of an improvement plan rBC^{f} in a case where description content of description data is fixed. In the improvement plan rBC^{f}, the description content of (b) customer and (c) problem is fixed. On the other hand, the dependency relationship (arrows a1 to a7) in the improvement plan rBC^{f} indicated in FIG. 6 is the same as the dependency relationship in the improvement plan rBC indicated in FIG. 4.

As described with reference to FIG. 4, normally, the improvement description content of the downstream item is created based on the improvement description content of the upstream item. On the other hand, in a case where the item for which the description content is fixed is located on the downstream side, the improvement description content of the upstream content is created based on the description content of the downstream item. Specifically, as indicated in the creation order CO^{f}, the preparation assistance system 50 first creates improvement description content of (a) social background based on the description content of (c) problem. Concerning (b) customer and (c) problem, the preparation assistance system 50 does not perform processing of improvement plan creation 5. Then, the preparation assistance system 50 second creates improvement description content of (d) solution based on the description content of (c) problem in accordance with the arrow a4. Then, the preparation assistance system 50 third creates the improvement description content of (e) effect based on the description content of (c) problem and the improvement description content of (d) solution in accordance with the arrows a5 and a6. Then, the preparation assistance system 50 fourth creates the improvement description content of (f) profit based on the description content of (b) customer and the improvement description content of (e) effect in accordance with the arrows a3 and a7.

By using fixing of the description content, for example, the description content of (a) social background that is the upstream item is created based on the description content of (c) problem that is the downstream item as in the first processing of the creation order CO^{f}. While the creation order CO indicates the order similar to a typical way of thinking in a case where the business concept is prepared, in a case where the items are fixed, the description content can be created while going back the way of thinking. For example, in a case where the user of the preparation assistance system 50 has an advantage in the solution but cannot specify the problem and the customer, the preparation assistance system 50 can create the description content regarding the problem and the customer while going back from the solution. The user of the preparation assistance system 50 can obtain suggestion for discovering an unexplored problem and a potential customer from the preparation assistance system 50.

### Comment Search

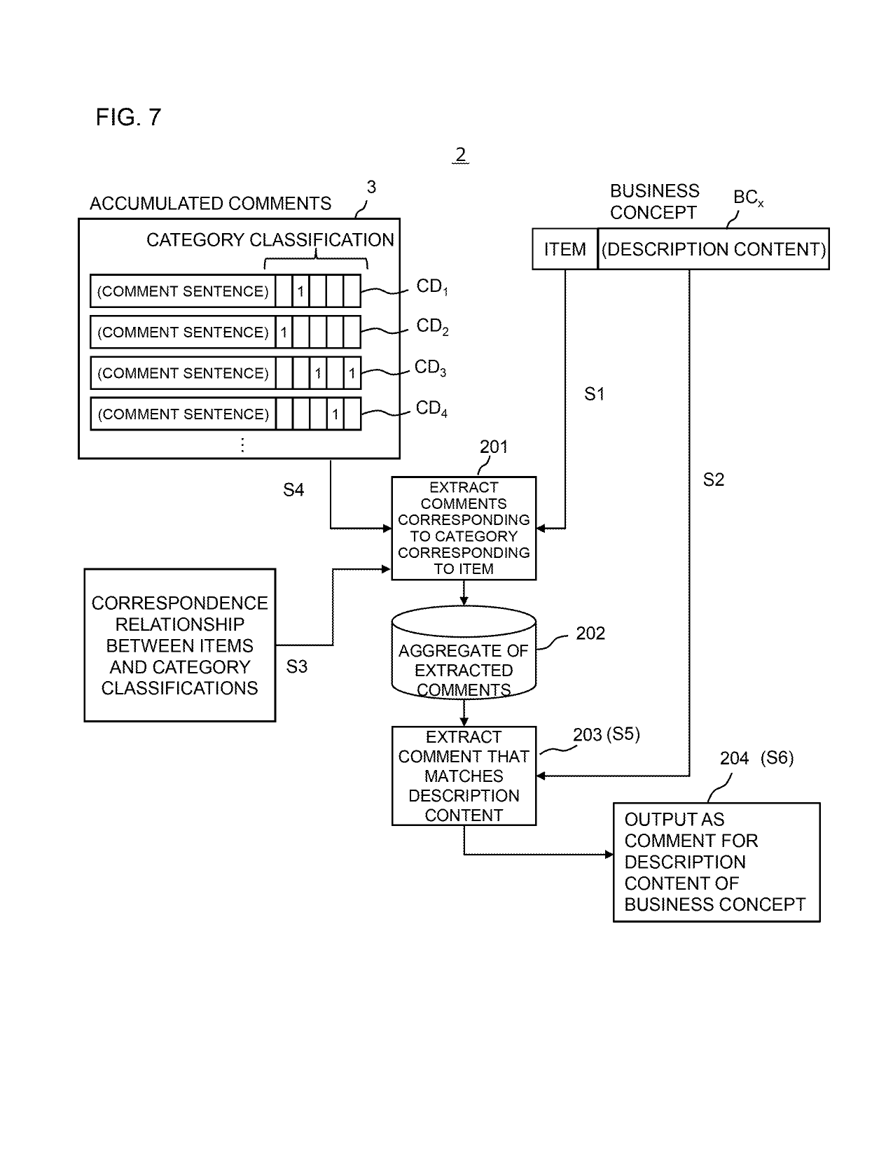

FIG. 7 is a view schematically indicating processing of comment search 2. Note that steps S1 to S6 indicated in FIG. 7 will be described later.

In a case where business concept input 1 is performed and the business concept BC is input, in the processing of comment search 2, the preparation assistance system 50 searches for comments for each piece of description data (items and description content) of the business concept BC. In FIG. 7, the description data BCₓ (in the present disclosure, x indicates alphabets corresponding to items from a to f) of the business concept BC includes items (such as, for example, "(a) social background") and description content.

Further, the accumulated comments 3 include a plurality of pieces of comment data CDᵢ (i is a positive integer). The comment data CDᵢ includes a comment sentence and a category classification indicating into which category, the comment data is classified. Each of the plurality of pieces of comment data is classified into one or a plurality of categories. The category will be described later. The plurality of pieces of comment data CDᵢ can be also referred to as an aggregate of comments.

In the processing of comment search 2, first, the preparation assistance system 50 extracts comments corresponding to a category corresponding to the item (processing 201). A correspondence relationship is defined in advance between the items of the business concept BC and the categories of the comment data CDᵢ. The preparation assistance system 50 searches for first comment data from the plurality of pieces of comment data based on the correspondence relationship. Specifically, the preparation assistance system 50 extracts comment data CDᵢ corresponding to the category corresponding to the item of description data BCₓ from the accumulated comments 3. The aggregate of comments is formed by the extracted comment data CDᵢ (processing 202).

Then, the preparation assistance system 50 extracts a comment that matches the description content of the business concept BC from the extracted aggregate of comments (processing 203). The preparation assistance system 50 searches for second comment data from the first comment data based on the description content of the business concept BC. Specifically, the preparation assistance system 50 extracts the comment data CDᵢ including the comment sentence that matches the description content of the description data BCₓ. A method for extracting a comment that matches the description content will be described later.

Then, the preparation assistance system 50 outputs the extracted comments as the comments for the description content of the business concept (processing 204). The preparation assistance system 50 presents the comment sentence of the extracted comment data CDᵢ in the processing of business concept improvement plan output 6.

The above-described processing of comment search 2 is basically performed for each piece of the description data BCₓ included in the business concept BC.

### Example of Processing 203

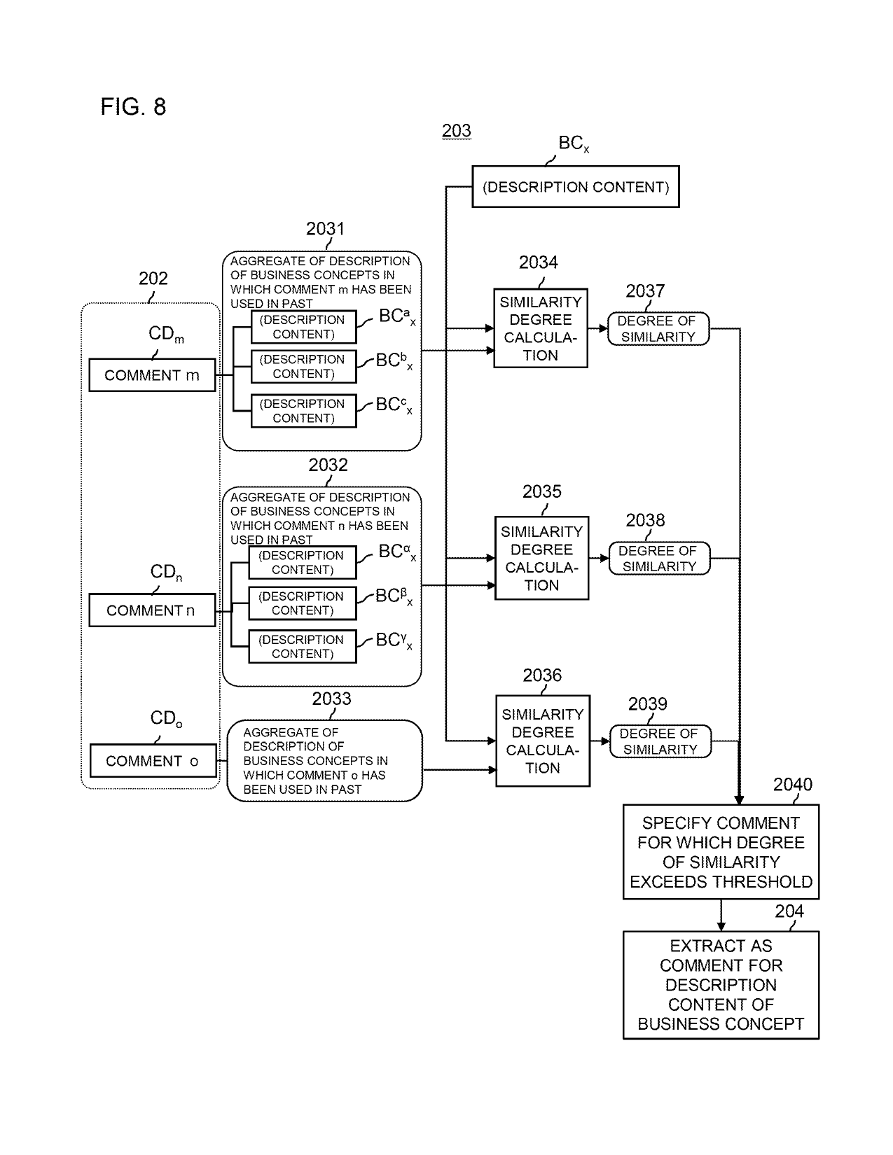

FIG. 8 is a view schematically indicating the method for extracting a comment that matches the description content. FIG. 8 indicates an example of a case where processing 203 in FIG. 7 is specifically performed. FIG. 8 indicates a case where CDₒ is extracted from the comment data CDₘ in processing 202 in FIG. 7. History information including other description data different from the description data BCₓ is associated with each of the plurality of pieces of comment data CD. In the extraction method indicated in FIG. 8, history information indicating a case where the comment data extracted in processing 202 has been extracted in preparation assistance of other business concepts is used. Note that the history information only requires to include the description content among the description data, and the description data may be description data to which items different from the items of the description data BCₓ are assigned. In the present disclosure, to facilitate understanding, a case will be described where the description content included in the history information is description content described in items that are the same as the items of the description data BCₓ.

History information 2031 indicates an aggregate of description of the business concept in which the comment m (comment sentence of the comment data CDₘ) has been used in the past. The history information 2031 includes description content of the description data of the business concept from which the comment data CDₘ has been extracted in preparation assistance of the business concept performed in the past. Specifically, description data BC^{a} ₓ is description data of a business concept BC^{a}. In a similar manner, description data BC^{b} ₓ is description data of a business concept BC^{b}. Description data BC^{c} ₓ is description data of a business concept BC^{c}. The business concepts BC^{a} to BC^{c} are business concepts which have been input to the preparation assistance system 50 in the past, and for which preparation assistance of the business concepts has been performed. Item names common to the description data BCₓ of the business concept BC are assigned to all of the description data BC^{a} ₓ to BC^{c} ₓ.

The preparation assistance system 50 calculates a degree of similarity between the description content of the description data BCₓ and the description content of the description data included in the history information 2031 (similarity degree calculation 2034). A degree of similarity 2037 to be calculated can be, for example, an average value of a degree of similarity between the description content of the description data BCₓ and the description content of the description data BC^{a} ₓ, a degree of similarity between the description content of the description data BCₓ and the description content of the description data BC^{b} ₓ, and a degree of similarity between the description content of the description data BCₓ and the description content of the description data BC^{c} ₓ. Note that while an example of a method for calculating the degree of similarity 2037 has been described, the present disclosure is not limited to this case. The degree of similarity between the description content of the description data BCₓ and the description content of the description data included in the history information 2031 may be calculated using other methods.

In a similar manner, the history information 2032 indicates an aggregate of description of the business concepts in which the comment n (description content of the comment data CDₙ) has been used in the past. The description data BC^{α} ₓ is description data of a business concept BC^{α}. In a similar manner, the description data BC^{β} ₓ is description data of a business concept BC^{β}. The description data BC^{γ} _{y} is description data of a business concept BC^{γ}. The business concepts BC^{α} to BC^{γ} are business concepts that have been input in the preparation assistance system 50 in the past. Item names common to the description data BCₓ of the business concept BC are provided to all the description data BC^{a} ₓ to BC^{c} ₓ. Note that a case has been described where the business concepts BC^{a} to BC^{c} in the history information 2032 are different from the business concepts BC^{a} to BC^{c} included in the history information 2031, the present disclosure is not limited to this case. The history information may include the same business concept. This similarly applies to history information 2033 to be described later.

Then, the preparation assistance system 50 calculates a degree of similarity between the description content of the description data BCₓ and the description content of the description data included in the history information 2032 in a similar manner to the case of the history information 2031 (similarity degree calculation 2035) and calculates a degree of similarity 2038.

In a similar manner, the history information 2033 indicates an aggregate of description of the business concepts for which the comment o (description content of the comment data CDₒ) has been used in the past. The preparation assistance system 50 calculates a degree of similarity between the description content of the description data BCₓ and the description content of the description data included in the history information 2032 in a similar manner to the case of the history information 2031 (similarity degree calculation 2036) and calculates a degree of similarity 2039.

Then, the preparation assistance system 50 specifies a comment for which the degree of similarity exceeds a threshold (processing 2040). The preparation assistance system 50 determines whether or not the degrees of similarity 2037 to 2039 exceed the threshold determined in advance. The preparation assistance system 50 specifies comment data (second comment data) corresponding to the history information having the degree of similarity exceeding the threshold among the history information 2031 to 2033. A degree of similarity between the description content of the description data included in the history information for the specified comment data and the description content of the description data BCₓ exceeds the predetermined threshold. The specified comment data is used in processing 204, and the preparation assistance system 50 presents a comment sentence of the specified comment data to the user.

### Data Structure of Business Concept

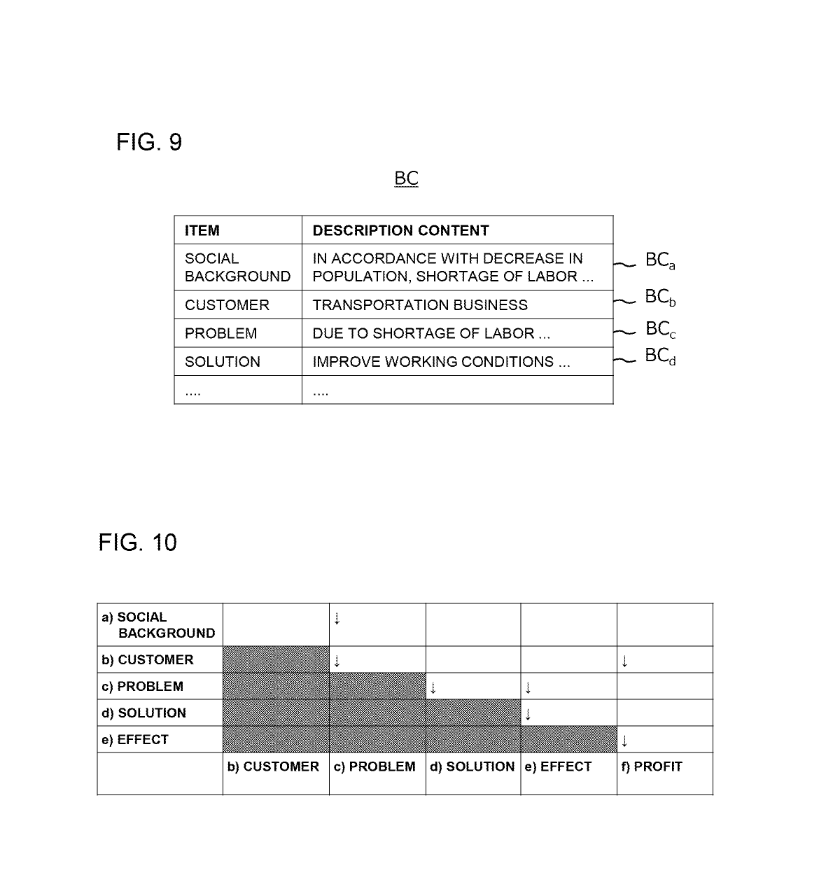

FIG. 9 is a view indicating an example of a data structure of the business concept. The business concept BC has a data structure storing items and description content. Data included in each row corresponds to description data of the business concept BC. For example, the description data BCₐ includes the item "social background" and information of "in accordance with decrease in population, shortage of workers is ..." as the description content. In a similar manner, other description data BC_{b} to BC_{d} include the items and the description content.

### Data Structure of Dependency Relationship between Items of Business Concept

FIG. 10 is a view indicating an example of a case where the dependency relationship between the items of the business concept BC is represented in the data structure. The items of the business concept BC are indicated in a matrix format, and the dependency relationship is indicated with an upward or downward arrow for a set (cell) of the items having the dependency relationship. Note that the arrow may be replaced with a numerical value such as 1 and 2 in a calculator.

For example, a downward arrow indicated for a set of (a) social background and (c) problem represents that there is a dependency relationship from (a) social background to (c) problem and corresponds to the arrow a1 indicated in FIG. 3. In the present disclosure, a source side of the arrow will be referred to as an upstream side, and a destination side of the arrow will be referred to as a downstream side for convenience sake. (a) Social background is an upstream item of (c) problem. In a similar manner, an arrow indicated for a set of (b) customer and (c) problem corresponds to the arrow a2 in FIG. 3. An arrow indicated for a set of (b) customer and (f) profit corresponds to the arrow a3 in FIG. 3. An arrow indicated for a set of (c) problem and (d) solution corresponds to the arrow a4 in FIG. 3. An arrow indicated for a set of (c) problem and (e) effect corresponds to the arrow a5 in FIG. 3. An arrow indicated for a set of (d) solution and (e) effect corresponds to the arrow a6 in FIG. 3. An arrow indicated for a set of (e) effect and (f) profit corresponds to the arrow a7 in FIG. 3.

### Data Structure of Comment Data

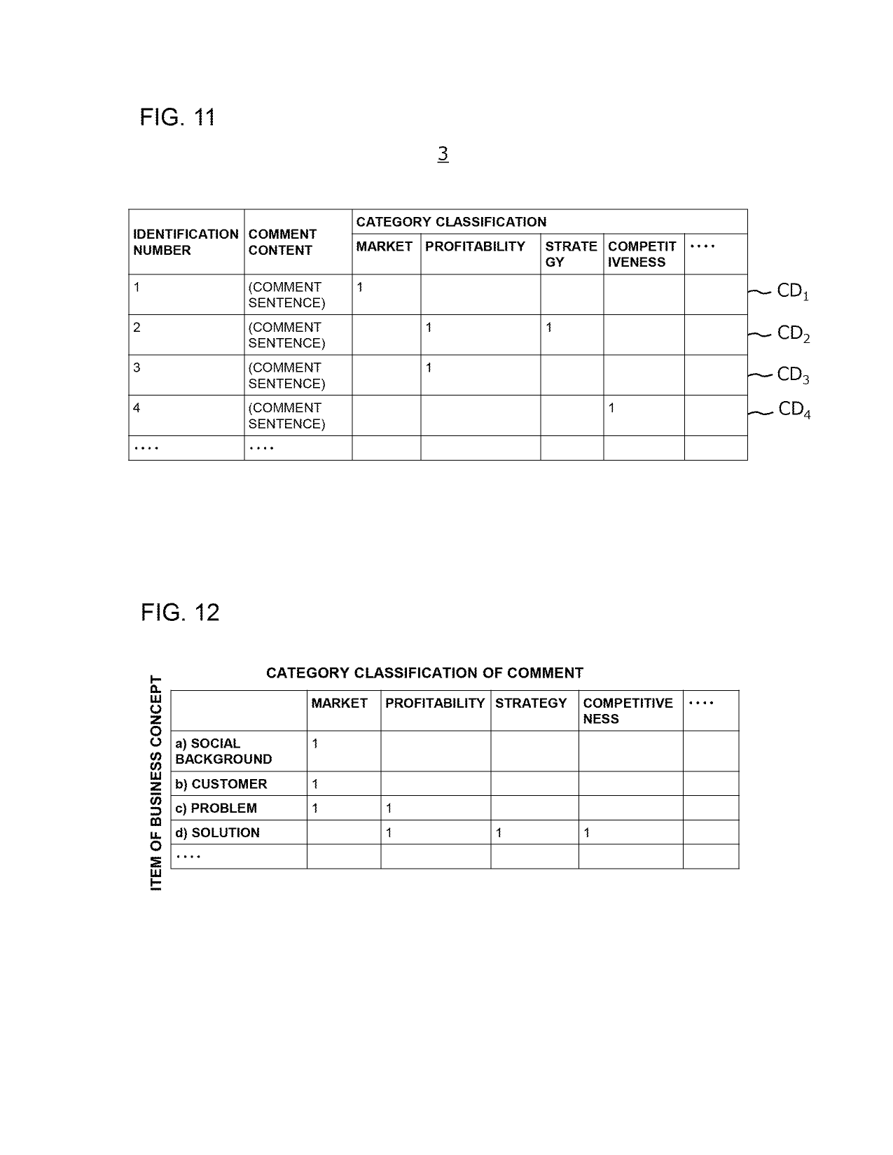

FIG. 11 is a view indicating an example of a data structure of the accumulated comments 3. Data included in each row corresponds to the commend data CD. The comment data CD includes an identification number, a comment sentence, and a category classification indicating into which category the comment data is classified. Concerning the category classification, a numerical value of 1 is stored in a field of the category to which content of the comment sentence corresponds.

As the category classifications, market, profitability, strategy, and competitiveness are indicated. At least one category classification is assigned to the comment data CD based on content of the comment data (content of the comment sentence). For example, market is assigned to the comment data CD₁ as the category classification. Further, a plurality of category classifications may be assigned to one piece of comment data, and for example, profitability and strategy are assigned to the comment data CD₂ as the category classifications. The category classification may be assigned by the user in accordance with the comment sentence. Further, the comment data to which the category classification is assigned in accordance with the comment sentence may be prepared by the document processing apparatus 30 and may be stored in a secondary storage unit 24. Note that the category classifications are not limited to market, profitability, strategy, and competitiveness, and classifications from other perspectives may be assigned.

### Correspondence Relationship between Items of Business Concept and Category Classifications of Comment Data

FIG. 12 is a view indicating an example of a correspondence relationship between the items of the business concept BC and the category classifications of the comment data CD. The items of the business concept BC are indicated on a vertical axis, and the category classifications to be assigned to the comment data CD are indicated on a horizontal axis. A numerical value of 1 is stored in a set having the correspondence relationship.

For example, "market" is associated with "(a) social background" of the business concept BC as the category. Further, in a similar manner, the category of "market" is associated with the item of "(b) customer". The categories of "market" and "profitability" are associated with the item "(c) problem". The categories "profitability", "strategy", and "competitiveness" are associated with the item "(d) solution". Note that while a case has been described where the correspondence relationship is set according to whether or not there is correspondence, the present disclosure is not limited to this case. For example, the correspondence relationship may be represented with a continuous value from 0.0 to 1.0 in accordance with a level of the relation. Further, the correspondence relationship between the items and the category classifications may be set in advance in the preparation assistance system 50 or may be set by the user.

### Comment Search Processing

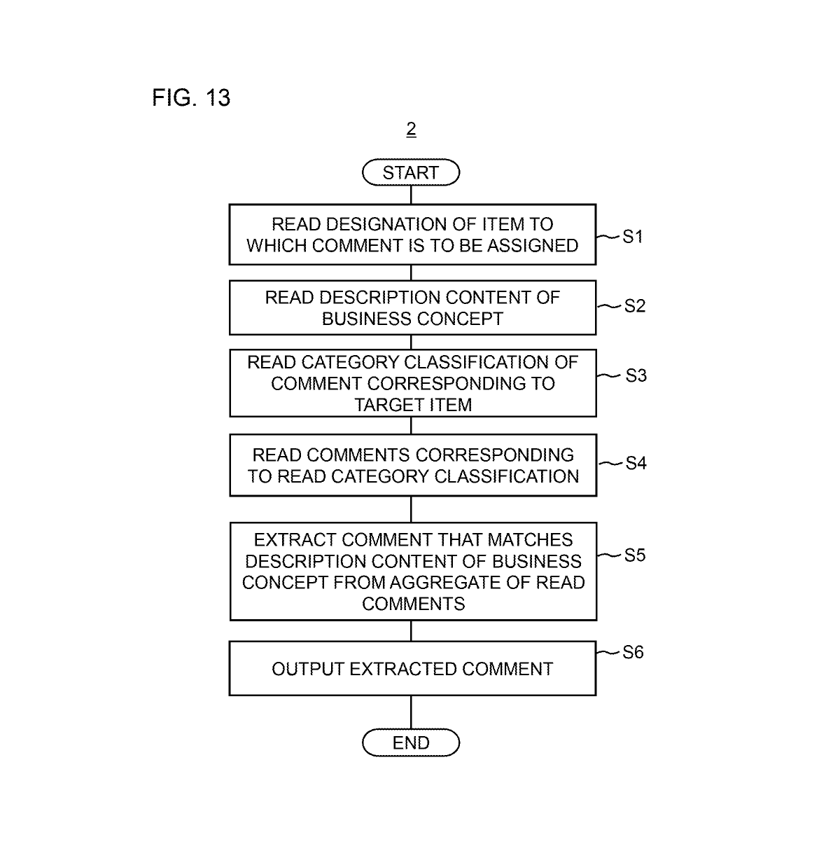

The processing of the preparation assistance system 50 in the configuration illustrated in FIG. 2 will be described using a flowchart with reference to FIGS. 13-16. The following description will be provided in association with the configuration of the preparation assistance system 50 illustrated in FIG. 2. As a result of the calculation processing unit 22 functioning so as to execute a processing command included in the main storage unit 23, the processing by the processing apparatus 20 is performed.

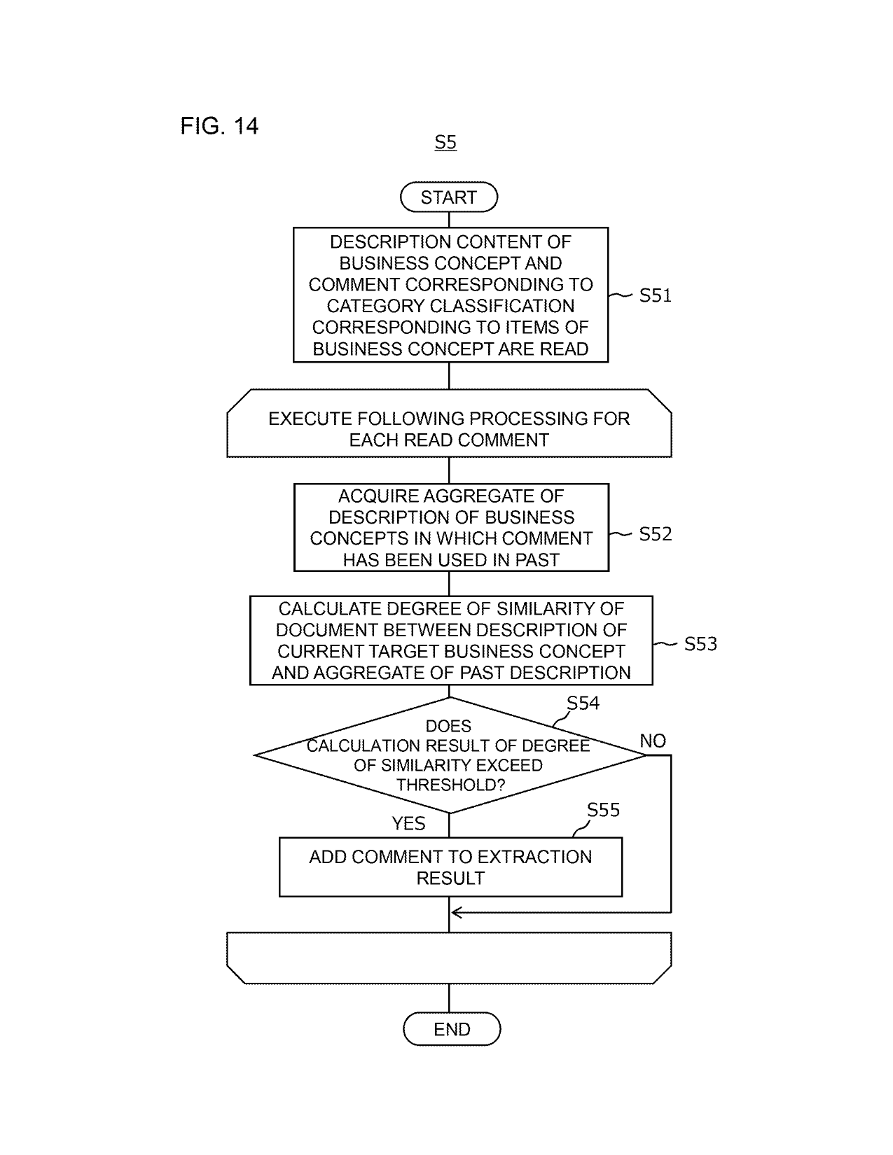

In the processing indicated in FIGS. 13 and 14, the preparation assistance system 50 searches for the first comment data from the plurality of pieces of comment data based on the correspondence relationship and searches for the second comment data from the first comment data based on the description content of the business concept. This will be specifically described below.

FIG. 13 is a flowchart indicating the processing of comment search 2. In the following description, there is a case where FIG. 7 is referred to. In the processing of comment search 2, first, the preparation assistance system 50 reads designation of an item to which a comment is to be assigned (step S1). The designation of the item corresponds to an item included in the description data BCₓ of the business concept BC. Step S1 in FIG. 13 corresponds to step S1 in FIG. 7. As indicated in step S1 in FIG. 7, the processing apparatus 20 reads the item from the description data BCₓ of the business concept BC. Note that reading refers to, for example, making it possible for the calculation processing unit 22 to perform processing. Specifically, in the processing of business concept input 1, the business concept BC input from the user terminal apparatus 10 is stored in the secondary storage unit 24 of the processing apparatus 20. In step S1, the calculation processing unit 22 loads data indicating the item from the secondary storage unit 24 to the main storage unit 23 so that the data can be processed.

Then, the preparation assistance system 50 reads the description content of the business concept (step S2). Step S2 in FIG. 13 corresponds to step S2 in FIG. 7. In a similar manner to step S1, the processing apparatus 20 reads the description content included in the description data BCₓ.

Then, the preparation assistance system 50 reads the category classification of the comment corresponding to the target item (step S3). Step S3 in FIG. 13 corresponds to step S3 in FIG. 7. The processing apparatus 20 reads the category classification corresponding to the target item with reference to the correspondence relationship between the items and the category classifications.

Then, the preparation assistance system 50 reads the comments corresponding to the read category classification from the accumulated comments 3 (step S4). Step S4 in FIG. 13 corresponds to the processing 201 in FIG. 7. As a result, the extracted aggregate of comments 202 can be obtained. Subsequently, the preparation assistance system 50 extracts a comment that matches the description content of the business concept from the extracted aggregate of comments 202 (step S5). Step S5 in FIG. 13 corresponds to the processing 203 in FIG. 7. The processing apparatus 20 extracts the comment data CD to which the category classification corresponding to the item read in step S1 is assigned (searches for the first comment data) based on the correspondence relationship between the items and the categories. Then, the processing apparatus 20 extracts the comment data CD for which the content of the comment sentence matches the description content of the description data BCₓ (searches for the second comment data) among the extracted aggregate of the comment data CD.

Then, the preparation assistance system 50 outputs the extracted comment (step S6). Step S6 in FIG. 13 corresponds to the processing 204 in FIG. 7. The processing apparatus 20 causes the comment sentence of the extracted comment data CD to be output to the output unit 12 of the user terminal apparatus 10 to present the comment sentence to the user.

### Processing Description for Extracting Comment that Matches Description Content of Business Concept

FIG. 14 is a flowchart indicating details of step S5 in FIG. 13. Note that FIG. 14 is also a flowchart indicating the processing 203 in FIG. 8, and thus, there is a case where FIGS. 13 and 8 are referred to in the following description.

In a case where the processing in step S5 is performed, it is a state in which the description content of the business concept BC and the comment data CD to which the category classifications corresponding to the items of the business concept BC are assigned are read (step S51). The processing apparatus 20 reads the business concept BC and a plurality of pieces of comment data CD to which the category classifications corresponding to the items of the business concept BC are assigned.

Then, the preparation assistance system 50 acquires an aggregate of description of the business concept BC^{χ} in which the comment has been used in the past (step S52). The processing apparatus 20 searches for history information including the description data BC^{χ} of the business concept BC^{χ} associated with the comment data CD from the secondary storage unit 24. In a case where the read comment data CD is extracted in the past preparation assistance, the history information is acquired as indicated in, for example, the history information 2031 in FIG. 8.

Then, the preparation assistance system 50 calculates a degree of similarity of a document between the description of the current target business concept BC and an aggregate of the past description (step S53). As indicated in similarity degree calculation 2034 in FIG. 8, the processing apparatus 20 calculates the degree of similarity 2037 from the history information 2031.

Then, the preparation assistance system 50 determines whether or not a calculation result of the degree of similarity exceeds a threshold (step S54). As indicated in the processing 2040 in FIG. 8, the processing apparatus 20 determines whether or not the degree of similarity 2037 exceeds the threshold.

In a case where the degree of similarity 2037 exceeds the threshold (step S54: Yes), the preparation assistance system 50 adds the comment to the extraction result (step S55). As indicated in step S6 in FIG. 13 (and the processing 204 in FIG. 8), the processing apparatus 20 adds the comment sentence of the comment data CD to the extraction result in the preparation assistance and outputs the extraction result.

The processing from step S52 to step S55 is executed for each comment that has been read. In the case of FIG. 8, the processing apparatus 20 acquires the history information 2032, performs similarity degree calculation 2035 and the processing 2040 of comparing the calculated degree of similarity 2038 with the threshold, and determines whether or not to add the comment to the extraction result. Subsequently, similar processing is performed for the history information 2033. Note that in a case where it is determined in step S54 that the degree of similarity does not exceed the threshold, the processing from step S52 to step S55 is performed also for other history information.

### Business Concept Preparation Assistance Processing

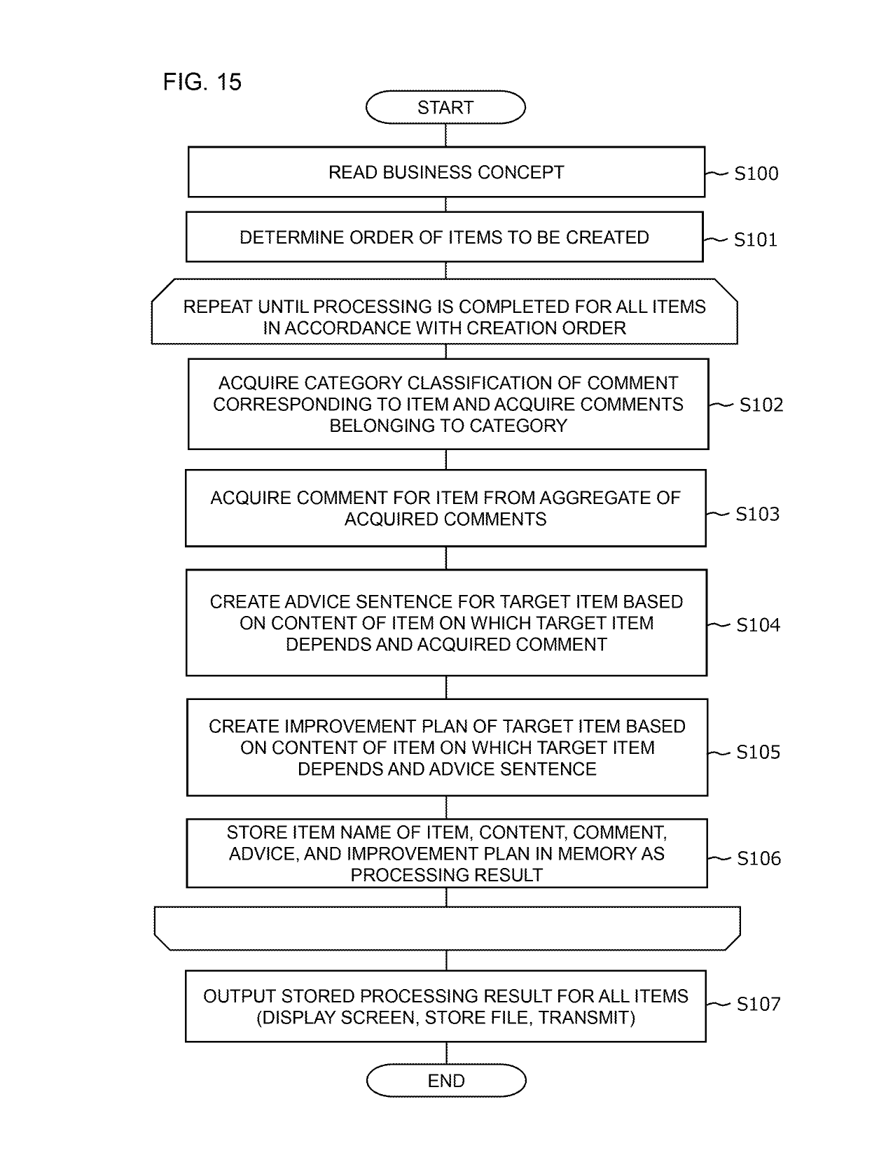

FIG. 15 is a flowchart indicating processing of preparation assistance of the business concept BC. This will be specifically described below.

First, the preparation assistance system 50 reads the business concept (step S100). The business concept BC input from the user terminal apparatus 10 is stored in the secondary storage unit 24 of the processing apparatus 20. The processing apparatus 20 reads the business concept BC stored in the secondary storage unit 24.

Then, the preparation assistance system 50 determines order of items to be created (step S101). The processing apparatus 20 determines creation order CO based on the dependency relationship between the items of the business concept BC. The determination method of the creation order CO will be described later.

The subsequent step S102 to step S106 are performed for each item in accordance with the creation order CO. The preparation assistance system 50 acquires a category classification of the comment corresponding to the item and acquires comments belonging to the category (step S102). The processing apparatus 20 acquires data indicating the item from the description data BCₓ of the business concept BC and acquires the category classification corresponding to the item based on the correspondence relationship between the items and the categories. The processing apparatus 20 acquires the comment data CD to which the category specified by the acquired category classification is assigned from the comment data CD stored in the secondary storage unit 24.

Then, the preparation assistance system 50 acquires the comment corresponding to the item from the acquired aggregate of comments (step S103). The processing in step S103 corresponds to the processing of comment search 2 indicated in FIGS. 7 or 13. The processing apparatus 20 acquires data indicating the comment sentence from the comment data CD acquired in step S102.

Then, the preparation assistance system 50 creates an advice sentence corresponding to the target item based on the content of the item on which the target item depends and the acquired comment (step S104). The preparation assistance system 50 creates an advice sentence for improving the description content in accordance with the creation order and using the item of the business concept as one creation target item based on the second comment data, the description content of the description data to which other items having a dependency relationship with the creation target item are assigned, and description content of the creation target item. The creation method of the advice sentence can be set as appropriate. For example, as will be described later, the processing apparatus 20 transmits data indicating the description data and the comment sentence on the upstream side of the processing target item to the document processing apparatus 30. The document processing apparatus 30 creates an advice sentence based on the data indicating the description data and the comment sentence and transmits the created advice sentence to the processing apparatus 20. Further, the advice sentence may be created in the processing apparatus 20 using natural language processing.

Then, the preparation assistance system 50 creates an improvement plan of the target item based on the content of the item on which the target item depends and the advice sentence (step S105). The preparation assistance system 50 creates the improvement plan of the description content in accordance with the creation order based on the advice sentence, the description content of the description data to which other items are assigned, and the description content of the business concept. The creation method of the improvement plan can be set as appropriate in a similar manner to the creation method of the advice sentence. For example, the improvement plan may be created in the document processing apparatus 30, after creation of the advice sentence. The created improvement plan is transmitted from the document processing apparatus 30 to the processing apparatus 20. Further, the improvement plan may be created in the processing apparatus 20 using natural language processing.

Note that in the creation of the advice sentence in step S104 and the creation of the improvement plan in step S105, the preparation assistance system 50 may perform learning for creating a document. For example, the processing apparatus 20 can learn whether or not it is necessary to correct the description content of the business concept based on the history information and a plurality of pieces of comment data. These kinds of learning may be performed in the document processing apparatus 30. A language model optimal for preparation of the business concept can be used, so that it is possible to more efficiently prepare the comment sentence and the correction plan of the business concept.

Then, the preparation assistance system 50 stores the item name of the item, content, the comment, the advice, and the improvement plan in a memory as a processing result (step S106). The processing apparatus 20 stores the data indicating the item, the description data, the comment sentence, the advice sentence, and the improvement plan processed from step S102 to step S106 in the main storage unit 23 as the processing result.

After the processing from step S102 to step S106 is performed for each item in accordance with the creation order CO, the preparation assistance system 50 outputs (displays a screen, stores a file, transmits) the stored processing result for all the items (step S107). The processing apparatus 20 transmits the processing result to the user terminal apparatus 10 and causes the processing result to be presented to the user at the user terminal apparatus 10. Further, the processing apparatus 20 stores the processing result in the secondary storage unit 24.

### Processing of Determining Creation Order of Items of Business Concept

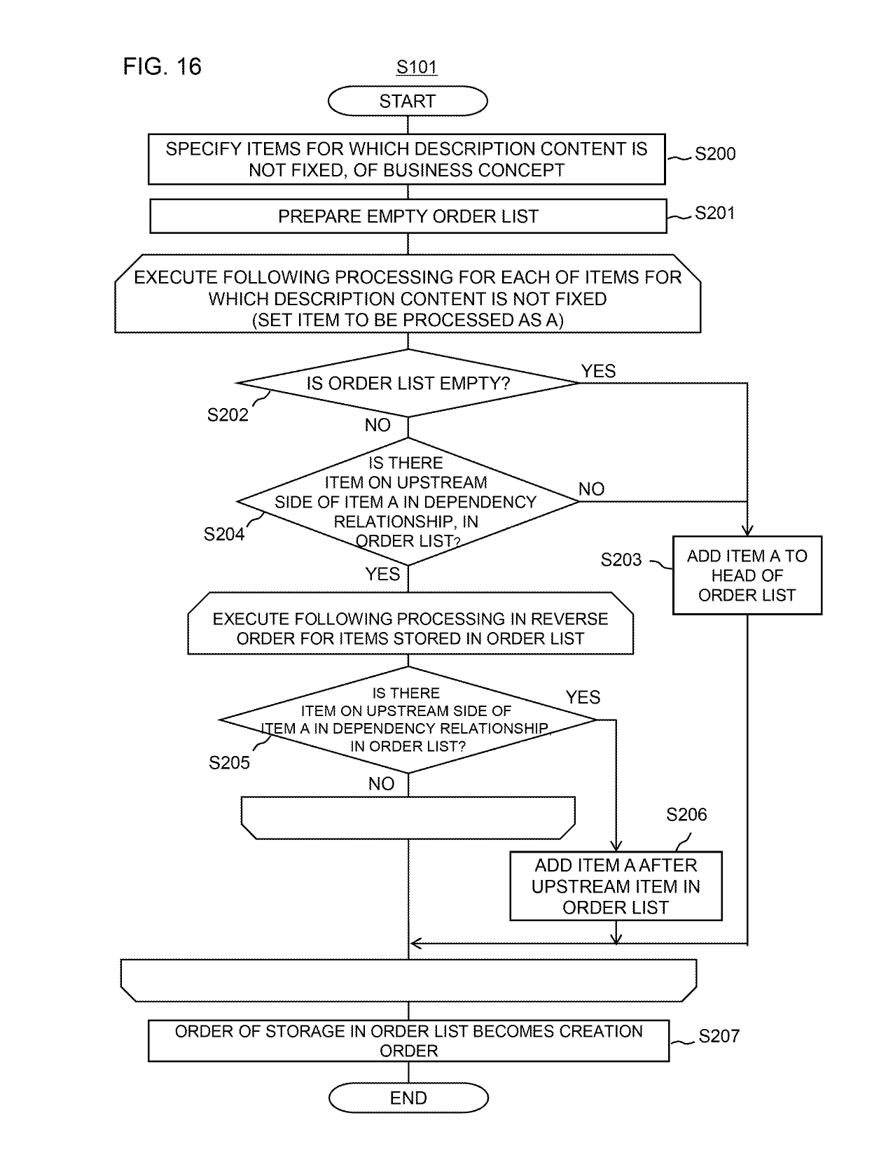

FIG. 16 is a flowchart indicating details of processing (step S102) of determining order of the items to be created among the processing indicated in FIG. 15. In the processing indicated in FIG. 16, the preparation assistance system 50 determines the creation order CO of creating the description content of the business concept and the improvement plan of the description content based on the dependency relationship, and the designation information designating the items for which the description content is fixed among the items of the business concept BC. This will be specifically described below.

First, the preparation assistance system 50 specifies the items for which the description content is not fixed, of the business concept BC (step S200). In a case where the business concept BC is input from the user terminal apparatus 10, the processing apparatus 20 determines whether or not the designation information indicating the items for which content of the description data BCₓ is fixed is assigned. Then, the processing apparatus 20 prepares an empty order list (step S201). The order list includes items obtained by excluding the items for which the description content is fixed from the items included in the business concept BC.

The subsequent step S202 to step S206 are performed for each item for which the description content is not fixed. For example, in the case indicated in FIG. 6, in a case where one cycle from step S202 to step S206 is performed for the first time, the item A indicates (a) social background. In a case where the second cycle is performed, the item A indicates (d) solution. In the third cycle, the item A is (e) effect, and in the fourth cycle, the item A is (f) profit. Note that while a case has been described where the items are assigned as the item A in alphabetical order, the items do not have to be assigned as the item A in alphabetical order.

The processing apparatus 20 determines whether or not the order list is empty (step S202). In a case where the order list is empty (step S202: Yes), the processing apparatus 20 adds the item A to the head of the order list (step S203).

In a case where the order list is not empty (step S202: No), the processing apparatus 20 determines whether or not there is an item on an upstream side of the item A in the dependency relationship, in the order list (step S204). In a case where there is an item on the upstream side in the order list (step S204: Yes), the processing apparatus 20 adds the item A after the upstream item, in the order list (step S206). A position at which the item A is to be added in the order list is determined by executing the processing in step S205 in reverse order for the items stored in the order list.

Note that in a case where there is no item on the upstream side in the order list (step S204: No), the processing in step S203 is performed. By the processing from step S202 to step S206 being performed for each item for which the description content is not fixed, the order of storage in the order list becomes the creation order (step S207). As a result of the processing from step S202 to step S206 being repeatedly performed, upstream and downstream relationships are compared among all the items. As a result, the items are arranged in accordance with the creation order in the order list.

### One Example of Instruction to Document Processing Apparatus

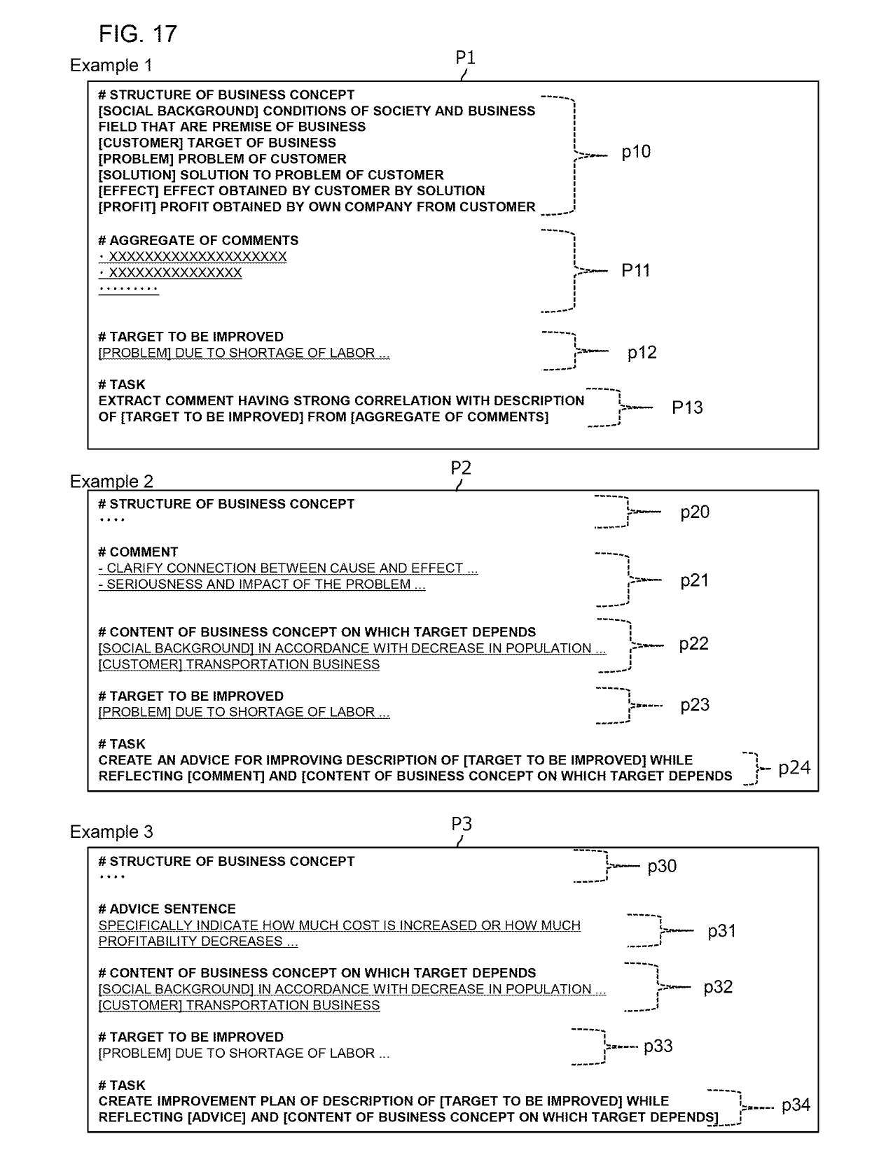

FIG. 17 is a view indicating an example of an instruction to the document processing apparatus 30. In the preparation assistance system 50, the processing apparatus 20 can perform comment search 2, advice sentence creation 4, and improvement plan creation 5 by causing the document processing apparatus 30 to perform document processing. Further, instructions P1 to P3 are a series of instructions to be transmitted from the processing apparatus 20 to the document processing apparatus 30, and, for example, the instructions P1 to P3 are respectively instructions from step S103 to step S105 in FIG. 15.

The instruction P1 indicates an instruction sentence in a case where an instruction to perform processing of searching for a comment from an aggregate of accumulated comments is given when the description content of the items of the business concept is provided. An input sentence P10 defines the description content of the items of the business concept BC. Definition is indicated for each of "social background", "customer", "problem", "solution", "effect", and "profit". An input sentence P11 indicates the acquired comment data CD as an aggregate of comments. A plurality of pieces of comment data CD is transmitted from the processing apparatus 20 to the document processing apparatus 30. An input sentence P12 indicates the item and the description content for which processing of preparing the improvement plan is to be performed. Specifically, in the input sentence P12, the problem is indicated as the item name, and "due to shortage of labor ..." is indicated as the description content. An input sentence P13 indicates a specific instruction to the document processing apparatus 30. Specifically, an instruction of "extract a comment having strong correlation with description of [target to be improved] from the [aggregate of comments]" is indicated in the input sentence P13.

An instruction P2 indicates an instruction sentence in a case where an instruction to perform processing of creating an advice sentence to improve the description content is given. An input sentence P20 defines the items and the description content of the business concept BC in a similar manner to the input sentence P10 of the instruction P1. An input sentence P21 indicates the comment data CD extracted from the document processing apparatus 30 by the instruction P1. Specifically, comment sentences of "⋅clarify connection between cause and effect ...", and "⋅seriousness and impact of the problem ..." are indicated in the input sentence P21.

An input sentence P22 indicates description data of an item (upstream item) having a dependency relationship with the item specified by an input sentence P23 which will be described later. Specifically, in the input sentence P22, social background is indicated as the item, "in accordance with decrease in population ..." is indicated as the description content, customer is indicated as the item, and "transportation business" is indicated as the description content. The input sentence P23 indicates an item and description content for which the preparation processing of the improvement plan is to be performed and indicates content similar to the input sentence P12 of the instruction P1. An input sentence P24 indicates a specific instruction to the document processing apparatus 30. Specifically, in the input sentence P24, an instruction of "create advice for improving description of [target to be improved] while reflecting [comment] and [content of business concept on which target depends]" is indicated.

An instruction P3 indicates an instruction sentence to be provided to the document processing apparatus 30 in a case where the document processing apparatus 30 is caused to execute the processing of creating the improvement plan of the description content. An input sentence P30 defines the items and the description content of the business concept BC in a similar manner to the input sentence P10 of the instruction P1. An input sentence P31 indicates an advice sentence created in the document processing apparatus 30 by an instruction P2. Specifically, in the input sentence P31, content of "specifically indicate how much cost is increased, or how much profitability decreases ..." is indicated.

An input sentence P32 indicates description data of an item (upstream item) having a dependency relationship with the item specified by an input sentence P33 which will be described later and indicates content similar to the input sentence P22 of the instruction P2. The input sentence P33 indicates an item and description content for which the processing of preparing the improvement plan is to be performed and indicates content similar to the input sentence P12 of the instruction P1. An input sentence P34 indicates a specific instruction to the document processing apparatus 30. Specifically, in the input sentence P34, an instruction of "create an improvement plan of description of [target to be improved] while reflecting [advice] and [content of business concept on which target depends]" is indicated.

### Format of Result Output

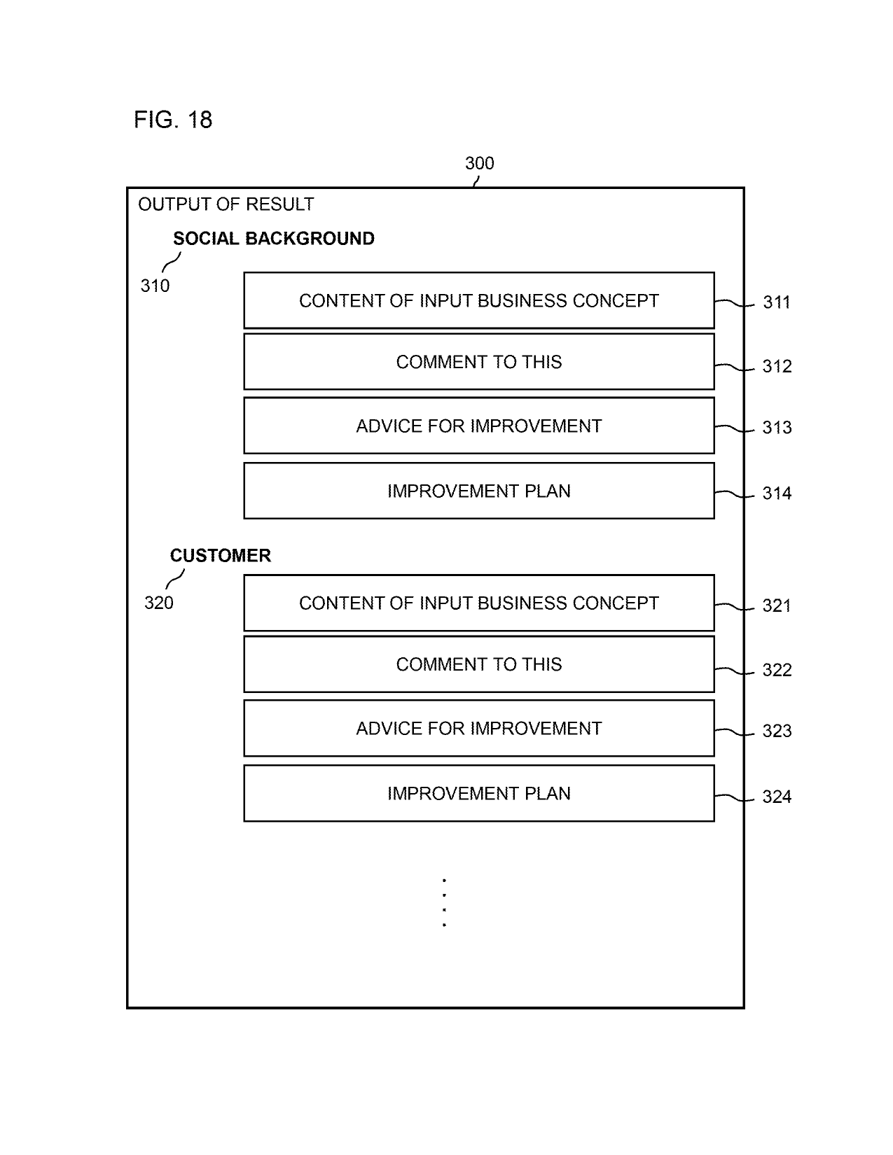

FIG. 18 is a view indicating an example of a format of a result output. An output screen 300 is indicated at the output unit 12 of the user terminal apparatus 10, for example, in step S107 in FIG. 15. An item portion 310 indicates an item of the business concept BC, and the item of "social background" is indicated. A display field 311 indicates description content associated with the item of social background among the business concept BC. A display field 312 indicates a comment sentence extracted for the description data in the display field 311. A display field 313 indicates an advice sentence extracted for the description data in the display field 311. A display field 314 indicates an improvement plan (improvement description content) created for the description data in the display field 311.

In a similar manner, an item portion 320 indicates an item name of the business concept BC, and the item of "customer" is indicated. A display field 321 indicates description content associated with the item of customer among the business concept BC. A display field 322 indicates a comment sentence extracted for the description data in the display field 321. A display field 323 indicates an advice sentence extracted for the description data in the display field 321. A display field 324 indicates an improvement plan created for the description data in the display field 321.

### Operation/Effects

As described above, according to the preparation assistance system of the present disclosure, it is possible to prepare an advice sentence regarding description content of a business concept and an improvement plan of the description content and indicate improvement policy of the business concept. Further, results of evaluation of the business concepts performed in the past are used as the comment data, and information resources in a company or organization can be utilized. The comment is extracted in view of a correspondence relationship with items of the business concept and a degree of similarity of the description content, so that it is possible to secure extraction accuracy of the comment. Further, an advice sentence and an improvement plan are created based on these information resources, so that it is possible to secure reliability of improvement policy.

While the embodiment of the present invention has been described above, the present invention is not limited to the above-described embodiment, and various changes can be made within a range not deviating from the gist of the present invention.

While aspects that can be content of the present invention will be described below, the aspects are not limited to these.

### Aspect 1

A preparation assistance system including a processor, a memory, and a storage unit including a plurality of pieces of comment data, the preparation assistance system assisting in preparation of a business concept, wherein
the business concept includes description data including items and description content,
each of the plurality of pieces of comment data is classified into one or a plurality of categories,
a correspondence relationship is defined in advance between the items of the business concept and the categories of the comment data, and
the memory includes a processing command for causing the processor to function so as to
search for first comment data from the plurality of pieces of comment data based on the correspondence relationship, and
search for second comment data from the first comment data based on the description content of the business concept.

### Aspect 2

The preparation assistance system according to aspect 1, wherein
a dependency relationship is defined between the items of the business concept, and
the memory includes a processing command for causing the processor to function so as to
determine creation order of creating the description content of the business concept and an improvement plan of the description content based on the dependency relationship and designation information designating an item for which the description content is fixed among the items of the business concept.

### Aspect 3

The preparation assistance system according to aspect 1 or 2,
wherein the memory includes a processing command for causing the processor to function so as to
create an advice sentence for improving the description content in accordance with the creation order using one of the items of the business concept as a creation target item based on the second comment data, description content of description data to which other items having a dependency relationship with the creation target item are assigned, and the description content of the creation target item.

### Aspect 4

The preparation assistance system according to any one of aspects 1 to 3,
wherein the memory includes a processing command for causing the processor to function so as to create an improvement plan of the description content in accordance with the creation order based on the advice sentence, the description data to which the other items are assigned, and the description content of the business concept.

### Aspect 5

The preparation assistance system according to any one of aspects 1 to 4,
wherein the preparation assistance system
further includes a user interface that acquires the business concept input by a user.

### Aspect 6

The preparation assistance system according to any one of aspects 1 to 5, wherein
history information including other description data different from the description data is associated with each of the plurality of pieces of comment data, and
a degree of similarity between description content of the other description data included in history information of the second comment data and the description content of the description data exceeds a predetermined threshold.

### Aspect 7

The preparation assistance system according to any one of aspects 1 to 6,
wherein the categories are assigned based on content of the comment data.

### Aspect 8

The preparation assistance system according to any one of aspects 1 to 7,
wherein the items include at least one of social background, customer, problem, solution, effect, or profit.

### Aspect 9

The preparation assistance system according to any one of aspects 1 to 8,
wherein the comment data includes results of evaluation performed for other business concepts different from the business concept.

### Aspect 10

The preparation assistance system according to any one of aspects 1 to 9,
wherein the designation information is set by a user of the preparation assistance system.

### Aspect 11

The preparation assistance system according to any one of aspects 1 to 10,
wherein the memory
further includes a processing command for causing the processor to function so as to learn whether or not it is necessary to correct the description content of the business concept based on the history information and the plurality of pieces of comment data.

### Aspect 12

A preparation assistance apparatus including a processor, a memory, and a storage unit including a plurality of pieces of comment data, the preparation assistance apparatus assisting in preparation of a business concept, wherein
the business concept includes description data including items and description content,
each of the plurality of pieces of comment data is classified into one or a plurality of categories,
a correspondence relationship is defined in advance between the items of the business concept and the categories of the comment data, and
the memory includes a processing command for causing the processor to function so as to
search for first comment data from the plurality of pieces of comment data based on the correspondence relationship, and
search for second comment data from the first comment data based on the description content of the business concept.

### Aspect 13

A preparation assistance method in a preparation assistance system that includes a processor, a memory, and a storage unit including a plurality of pieces of comment data, the preparation assistance method assisting in preparation of a business concept, wherein
the business concept includes description data including items and description content,
each of the plurality of pieces of comment data is classified into one or a plurality of categories,
a correspondence relationship is defined in advance between the items of the business concept and the categories of the comment data, and
the preparation assistance system
searches for first comment data from the plurality of pieces of comment data based on the correspondence relationship, and
searches for second comment data from the first comment data based on the description content of the business concept.

### REFERENCE SIGNS LIST

1: Business concept input
2: Comment search
3: Accumulated comments
4: Advice sentence creation
5: Improvement plan creation
6: Business concept improvement plan output
10: User terminal apparatus
11: Input unit
12: Output unit
13: Communication unit
20: Processing apparatus
21: Communication unit
22: Calculation processing unit
23: Main storage unit
24: Secondary storage unit
30: Document processing apparatus
50: Preparation assistance system
BC: Business concept
CD: Comment data
CO: creation order
rBC: Improvement plan

What is claimed is:

1. A preparation assistance system comprising a processor, a memory, and a storage unit including a plurality of pieces of comment data, the preparation assistance system assisting in preparation of a business concept, wherein
the business concept includes description data including items and description content,
each of the plurality of pieces of comment data is classified into one or a plurality of categories,
a correspondence relationship is defined in advance between the items of the business concept and the categories of the comment data, and
the memory includes a processing command for causing the processor to function so as to
search for first comment data from the plurality of pieces of comment data based on the correspondence relationship, and
search for second comment data from the first comment data based on the description content of the business concept.

2. The preparation assistance system according to claim 1, wherein
a dependency relationship is defined between the items of the business concept, and
the memory includes a processing command for causing the processor to function so as to
determine creation order of creating the description content of the business concept or an improvement plan of the description content based on the dependency relationship and designation information designating an item for which description content is fixed among the items of the business concept.

3. The preparation assistance system according to claim 2,
wherein the memory includes a processing command for causing the processor to function so as to
create an advice sentence for improving the description content in accordance with the creation order using one of the items of the business concept as a creation target item based on the second comment data, description content of description data to which other items having a dependency relationship with the creation target item are assigned, and the description content of the creation target item.

4. The preparation assistance system according to claim 3,
wherein the memory includes a processing command for causing the processor to function so as to create an improvement plan of the description content in accordance with the creation order based on the advice sentence, description data to which the other items are assigned, and the description content of the business concept.

5. The preparation assistance system according to claim 1,
wherein the preparation assistance system further includes
a user interface that acquires the business concept input by a user.

6. The preparation assistance system according to claim 1, wherein
history information including other description data different from the description data is associated with each of the plurality of pieces of comment data, and
a degree of similarity between description content of the other description data included in the history information of the second comment data and the description content of the description data exceeds a predetermined threshold.

7. The preparation assistance system according to claim 1,
wherein the categories are assigned based on content of the comment data.

8. The preparation assistance system according to claim 1,
wherein the items include at least one of social background, customer, problem, solution, effect, or profit.

9. The preparation assistance system according to claim 1,
wherein the comment data includes results of evaluation performed for other business concepts different from the business concept.

10. The preparation assistance system according to claim 2,
wherein the designation information is set by a user of the preparation assistance system.

11. The preparation assistance system according to claim 6,
wherein the memory further includes a processing command for causing the processor to function so as to
learn whether or not it is necessary to correct the description content of the business concept based on the history information and the plurality of pieces of comment data.

12. A preparation assistance apparatus comprising a processor, a memory, and a storage unit including a plurality of pieces of comment data, the preparation assistance apparatus assisting in preparation of a business concept, wherein
the business concept includes description data including items and description content,
each of the plurality of pieces of comment data is classified into one or a plurality of categories,
a correspondence relationship is defined in advance between the items of the business concept and the categories of the comment data, and
the memory includes a processing command for causing the processor to function so as to
search for first comment data from the plurality of pieces of comment data based on the correspondence relationship, and
search for second comment data from the first comment data based on the description content of the business concept.

13. A preparation assistance method in a preparation assistance system that includes a processor, a memory, and a storage unit including a plurality of pieces of comment data, and that assists in preparation of a business concept, wherein
the business concept includes description data including items and description content,
each of the plurality of pieces of comment data is classified into one or a plurality of categories,
a correspondence relationship is defined in advance between the items of the business concept and the categories of the comment data, and
the preparation assistance system
searches for first comment data from the plurality of pieces of comment data based on the correspondence relationship, and
searches for second comment data from the first comment data based on the description content of the business concept.
